(19) United States
(12) Patent Application Publication
(10) Pub. No.: US 2003/0101442 A1
(43) Pub. Date: May 29, 2003

(54) Method, apparatus, and system to formulate regions of reusable instructions

(76) Inventor: Youfeng Wu, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/965,757

(22) Filed: Sep. 28, 2001

(51) Int. Cl. G06F 9/45; G06F 9/44

(52) U.S. Cl. 717/156; 717/144

(57) ABSTRACT

The present invention relates to a method, apparatus, and system to formulate regions of reusable instructions. The method includes selecting initial regions. The method further includes computing UEU(E,R) and DED(X,R), wherein UEU(E,R) represents a number of upward exposed registers at a main entry E of a region R that are used in the region R and DED(X,R) represents a number of downward exposed registers at a main exit X of the region R that are defined in the region R. The method also includes applying code motion. The method additionally includes applying tail duplication.

### BACKGROUND

(1) Field

The present invention relates to a method, apparatus, and system to formulate regions of reusable instructions.

(2) General Background

Generally, the result of using a one-pass compiler is object code that executes much less efficiently than it might if more effort were expended in its compilation. Therefore, it is desirable to optimize the object code (or the intermediate code translated into the object code by the compiler). Some important optimizations may include optimizations that operate on loops (such as moving loop-invariant computations out of the loops and simplifying or eliminating computations on induction variables), global register allocation, and instruction scheduling.

There are other kinds of optimizations that may be relevant to a particular program. Optimizations that are relevant to a particular program tend to vary according to the structure and details of the program.

A highly recursive program, for example, may benefit significantly from tail-call optimization, which turns recursions into loops, and may only then benefit from loop optimizations. On the other hand, a program with only a few loops but with very large basic blocks within them may derive significant benefit from loop distribution (which splits one loop into several loops, with each loop body doing part of the work of the original one) or register allocation, but only modest improvement from other loop optimizations. Similarly, procedure integration or inlining, i.e., replacing subroutine calls with copies of their bodies, not only decreases the overhead of calling the subroutines but also may enable any or all of the intra-procedural optimizations to be applied to the result, with marked improvements that would not have been possible without inlining.

The types of optimizations briefly described above and other optimizations, including computation reuse, can make large differences in the performance of programs—frequently a factor of two or three and, occasionally, much more, in execution time.

### BRIEF DESCRIPTION OF THE DRAWINGS

FIG. 1 is a block diagram of an exemplary computing system in accordance with one embodiment of the present invention;

FIG. 2 is a partial block diagram of the exemplary computing system shown in FIG. 1, illustrating an exemplary code optimizer in accordance with one embodiment of the present invention;

FIG. 3 generally outlines the process of formulating regions of reusable instructions in accordance with one embodiment of the present invention;

FIG. 4 shows an exemplary situation when an empty block needs to be inserted; and

FIG. 5 provides an exemplary situation where an empty successor block may need to be created.

### DETAILED DESCRIPTION

The present invention relates to a method, apparatus, and system to formulate regions of reusable instructions.

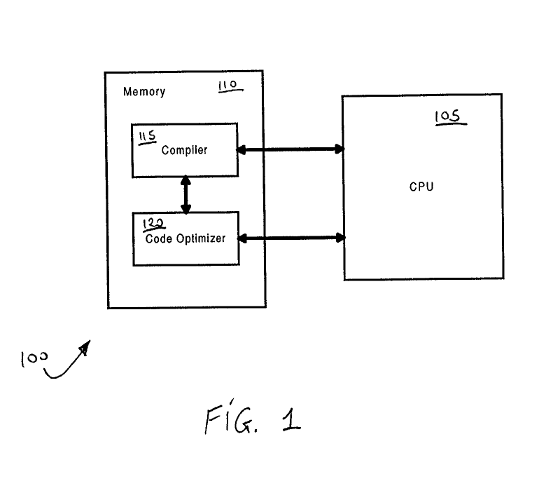

FIG. 1 is a block diagram of an exemplary computing system 100 in accordance with one embodiment of the present invention. Computing system 100 includes a central processing unit (CPU) 105 and memory 110 that is cooperatively connected to the CPU 105. CPU 105 can be used to execute a compiler 115 and a code optimizer 120, which are stored in the memory 110. Compiler 115 is generally used to generate object code from a computer program written in a standard programming language. Code optimizer 120 is generally used to optimize the object code generated by the compiler 115 to generally make the object code more efficient.

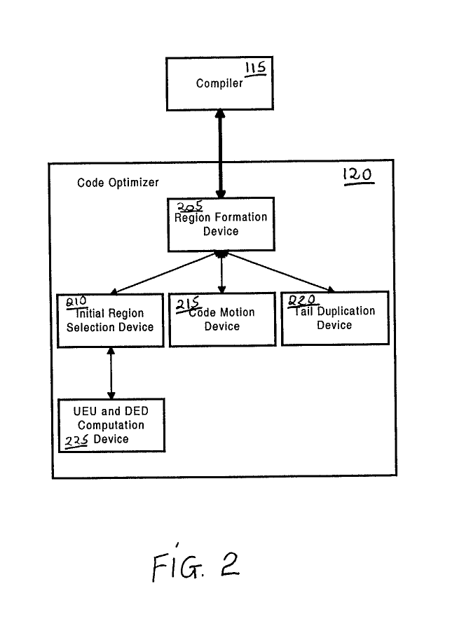

FIG. 2 is a partial block diagram of the exemplary computing system shown in FIG. 1, illustrating an exemplary code optimizer 120 in accordance with one embodiment of the present invention. Code optimizer includes a region formation device 205, a device 210 to select initial regions, a code motion device 215, a tail duplication device 220, and a device 225 to compute the UEU(E,R) and DED (X,R) of a region R having the main entry E and the main exit X. UEU(E,R) generally represents the number of upward exposed registers at the main entry E that are used inside the region R. DED(X,R) generally represents the number of downward exposed registers at the main exit X that are defined in the region R and used after the region. Region formation device 205, initial region selection device 210, code motion device 215, tail duplication device 220, and a UEU and DED computation device 225 work together to form regions of reusable instructions, as will be described below in more detail.

Generally for computation reuse, regions of reusable instructions need to be formulated. Program analysis or value profile typically provides information about the reusability of individual instructions. Each reuse region should contain reusable instructions. Prior to using the inventive technique of formulating regions of reusable instructions described below, basic blocks should have been formulated such that each block should contain either all reusable instructions or all non-reusable instructions, but not both. An empty block would be viewed as a block containing reusable instructions.

Given a control flow graph with a subset of blocks and some of the innermost loops marked as reusable, the inventive technique generally forms regions of reusable instructions such that each region (R) would meet the following exemplary conditions:

Each region contains only reusable instructions;

Each region has at least a minimal number, K, of reusable instructions;

Each region has a main entry and a main exit and all instructions inside the region are reachable from the main entry and all of them reach the main exit, via only instructions inside the region;

Each region R has at most a maximum number M of upward exposed registers (denoted UEU(E,R)) at the main entry E of the region that are used inside the region, and at most a maximum number N of downward exposed registers (denoted DED(X,R)) at the main exit X of the region that are defined in the region; and

Inner loops in the region should be properly nested inside the region. These inner loops should be reducible. Furthermore, the main entry is not a head of an inner loop; and the main exit is not a tail of an inner loop;

Furthermore, after the below described technique is applied to produce regions of reusable instructions, the total number of dynamic instructions executed in all regions from main entries to main exits should be maximized.

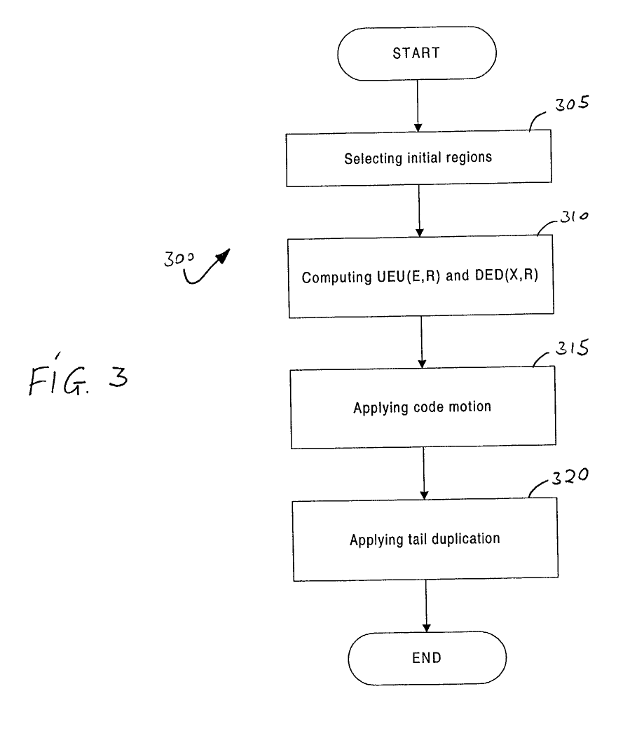

FIG. 3 generally outlines the process 300 of formulating regions of reusable instructions in accordance with one embodiment of the present invention. In block 305, initial regions are selected. In one embodiment, the device 210 of FIG. 2 can perform the selection of initial regions. In selecting initial regions, sub-control flow graphs are selected as regions such that the regions start execution mostly at the main entry and completes mostly at the main exit. An exemplary process of selecting initial regions will be described below in more detail.

In block 310, UEU(E,R) and DED (X,R) are computed and checked. In one embodiment, the computation of UEU(E,R) and DED(X,R) can be performed by device 225 of FIG. 2. As stated above, UEU(E,R) represents the number of upward exposed registers at the main entry E that are used inside the region R. DED(X,R) represents the number of downward exposed registers at the main exit X that are defined in the region R. An exemplary process of computing and checking the UEU(E,R) and DED (X,R) will be described below in more detail.

Block 315 generally involves grouping together reusable instructions, which are separated by non-reusable instructions, to form larger reusable regions. This grouping process is also known as applying code motion. In one embodiment, code motion can be applied by device 215 of FIG. 2. An exemplary process of applying code motion will be described below in more detail.

In block 320, tail duplication is applied. When a group of reusable instructions can be executed along multiple entry points, tail duplication of the reusable instructions allows all execution to be reused. In one embodiment, tail duplication can be performed by device 220 of FIG. 2. An exemplary process of applying tail duplication will be described below in more detail.

Block 305 of FIG. 3 shows the selecting of initial regions. As stated above, the selecting of initial regions can be performed by device 210 of FIG. 2. In general, the quality of a region is measured by the completion probability. The completion probability of a region is the probability that the execution reaches the main exit when the region is entered at the main entry. In selecting initial regions, regions with generally high completion are generally selected. To select initial regions, reusable blocks are visited in topological order. For each reusable block (denoted B), the following operations are performed:

Collect a set of reusable blocks that are reachable from B without going through loop back edge. If a block is an entry block of an inner loop and the loop is reusable, the loop entry block is added into the set of collected reusable blocks. Also, reachable blocks from the post-exit blocks of the loop should be visited.

Assume that the frequency for the block B is 1.0 and propagate the frequency from block B to all blocks reachable from block B. In doing so, inner loop should be treated as a single node and propagated from the entry block of the loop to the post-exit blocks of the loop.

For each reachable block, Xi, that is not inside an inner loop, perform the following actions:

First, if the frequency of the block is greater than the completion probability, form a region, Ri, having E as the main entry and Xi as the main exit. If the entry block of the inner loop is included in the formed region, the entire inner loop should also be included in the formed region.

Then, UEU(E,Ri) and DED(Xi,Ri) should be checked to ensure that they are within their respective limits of M and N. As defined above, UEU(E,Ri) represents the number of upward exposed registers at the main entry E that are used inside the region Ri; and M represents the maximum number of these upward exposed registers. As previously discussed, DED(Xi,Ri) represents the number of downward exposed registers at the main exit Xi that are defined in the region Ri; and N represents the maximum number of these downward exposed registers.

Afterward, each region Ri is check to ensure that the region includes at least G instructions. At this time, G is allowed to be less than K, which is defined above as the minimal number, of reusable instructions in a region, since additional instructions will be moved into the region Ri.

If the UEU(E,Ri) and DED(Xi,Ri) are within their respective limits or maximum numbers of M and N and the region Ri includes at least G instructions, the region Ri should be marked or remembered.

From the marked or remembered regions, select the best region R having the main entry E and the main exit X.

At this time, code motion will be applied or used to enlarge the region R having the main entry E and the main exit X.

It should be noted that the selection of initial regions should be performed until no additional regions can be formed.

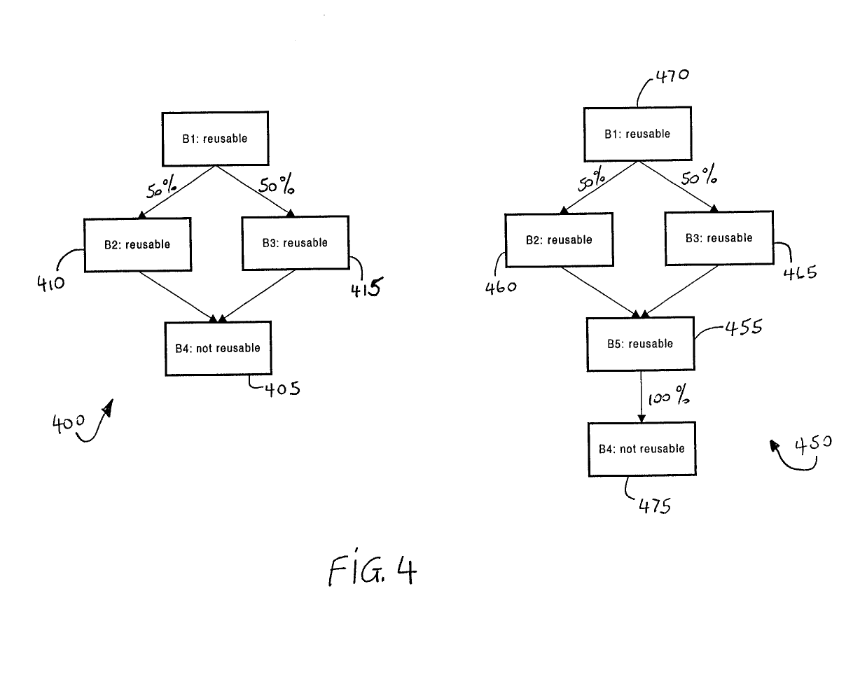

To form large region with high completion probability, empty blocks needs to be inserted so that every joined block can be reusable. FIG. 4 shows an exemplary situation when an empty block needs to be inserted. In the group 400 of blocks on the left of the figure, block B4 405 is not reusable and cannot be included inside the region. Therefore, blocks B2 410 and B3 415 cannot be included inside the region. Furthermore, the completion probability of the group 400 of blocks on the left of the figure is less than 50%. In the group 450 of blocks on the right of the figure, empty block B5 455 is inserted in the group. As a result, blocks B2 460 and B3 465 can be included inside the region. Furthermore, a region including blocks B1 470, B2 460, B3 465, and B5 455 has a completion probability of 100%.

As shown in block 310 of FIG. 3, the UEU(E,R) and the DED(X,R) of each region R needs to be computed and checked during the formation of the region. Each region R is generally described by its member blocks, its main entry E, and its main exit X. As previously stated, UEU(E,R) represents the number of upward exposed registers at the main entry E that are used inside the region R; and DED(X,R) represents the number of downward exposed registers at the main exit X that are defined in the region R. To explain in other words, UEU(E,R) represents the set of registers live-in at the main entry E and used inside the region; and DED(X,R) represents the set of registers live-out at the main exit X and defined inside the region R.

As stated above, the computation of UEU(E,R) and DED(X,R) can be performed by device 225 of FIG. 2. It should be noted that UEU(E,R) and DED(X,R) should be computed fairly quickly for performance reasons. Accordingly in one embodiment, UEU(E,R) and DED(X,R) are typically computed from region local information. Furthermore, global LIVEIN and LIVEOUT are used in the computation of UEU(E,R) and DED(X,R), but are computed only once. LIVEIN(b) represents the set of register living in block b; and LIVEOUT(b) represents the set of register living out of block b.

UEU(E,R) can be computed using the following equation (1):

$$U E U ( b , R ) = ( ( {⋃}_{{s ∈ s u c c ( b )}_{s ∈ R }} U E U ( s , R ) ) ) - D m u s t ( b ) ) ⋃ U ( b ) , fo r b ∈ R , \qquad ( 1 )$$

U(b) represents the set of registers that may be used before being defined in block b, and Dmust(b) represents the set of registers that must be defined in block b.

DED(X,R) can be computed using the following equation (2):

$$D E D ( b , R ) = ( ( {⋃}_{{p ∈ p r e d ( b )}_{p ∈ R }} D E D ( p , R ) ) - D m a y ( b ) ) ⋂ L I V E O U T ( b ) , fo r b ∈ R \qquad ( 2 )$$

where Dmay(b) represents the set of registers that may be defined in block b, and LIVEOUT(b) represents the set of registers living out of block b.

In short, given a region R with main entry E and main exit X, UEU(E,R) and DED(X,R) can be computed from region local information (including U(b), Dmust(b), and Dmay(b) for bεR) and the global LIVEOUT(b) for bεR. The global LIVEOUT information may change when code is moved across blocks. However, LIVEOUT will be maintained with the region local information when code is moved.

In one embodiment, U(b), Dmust(b), and Dmay(b) can be computed using the following logic described in the following pseudo-code.

U(b) = Dmust(b) = Dmay(b) = { };
for each instruction in b from first to last
begin

for each register r used in instruction
begin

if (r is not in Dmay(b)) then U(b) ∪ = r

end
for each register defined in instruction
begin

Dmay(b) ∪ = r
If (instruction is not predicated) then Dmust(b) ∪ = r

end

end

If region R is a Directed Acyclic Graph (DAG) region, the computation of UEU(b,R) and DED (b,R) can be efficiently performed in a topological order of the blocks in the region, using the following logic described in the following pseudo-code.

for each block b in region R in reverse topological order
begin

UEU(b,R) = { }
for each successor block s of block b
begin

UEU(b,R) ∪ = UEU(s,R)

End
UEU(b,R) −= Dmust(b)
UEU(b,R) ∪ = U(b)

end
for each block b in region R in topological order
begin

DED(b,R) = { }
For each predecessor block p of block b
begin

DED(b,R) ∪ = DED(p,R)

end
DED(b,R) ∪ = Dmay(b)
DED(b,R) ∩ = LIVEOUT(b)

end

If region R contains nested loops, the above logic needs to be repeated until a fixed point is achieved, as described in the following pseudo-code.

for each block b in region R
begin

UEU(b,R) = { }
DED(b,R) = { }

end
changed = 1
while (changed==1)
begin

changed = 0
for each block b in region R in reverse topological order
begin

new_UEU = { }
for each successor block s of block b

begin
new_UEU ∪ = UEU(s,R)

end
new_UEU ∪ = U(b)
if (UEU(b,R) != new_UEU)
begin

UEU(b,R) = new_UEU
changed = 1

end

end

end
changed = 1
while (changed==1)
begin

changed = 0
for each block b in region R in topological order
begin

new_DED = { }
for each predecessor block p of block b
begin

new_DED ∪ = DED(p,R)

end
new_DED ∪ = Dmay(b)
DED(b,R) ∩ = LIVEOUT(b)
if (DED(b,R) != new_DED)
begin

DED(b,R) = new_DED
changed = 1

end

end

end

Block 315 of FIG. 3 generally involves grouping together reusable instructions, which are separated by non-reusable instructions, to form larger reusable regions. This grouping process is also known as applying code motion. As stated above, code motion can be applied by device 215 of FIG. 2. An exemplary code motion process will now be described in more detail.

In performing code motion, for each candidate region R with main entry E and main exit X, instructions outside the region can be moved inside the region to be a part of the region. One way to do so is to move the instructions to the main exit block X and the main entry block E of the region R. Once the instructions are moved to the main exit block and the main entry block, they can be moved to other places inside the region. However, it can sometimes be insufficient to simply move instructions into the main entry block E and the main exit block X of the region R. For example, if the main exit block E ends with a conditional branch, an empty successor block may need to be created to help the upper-motioned code if the reuse region can be extended to include the successor block.

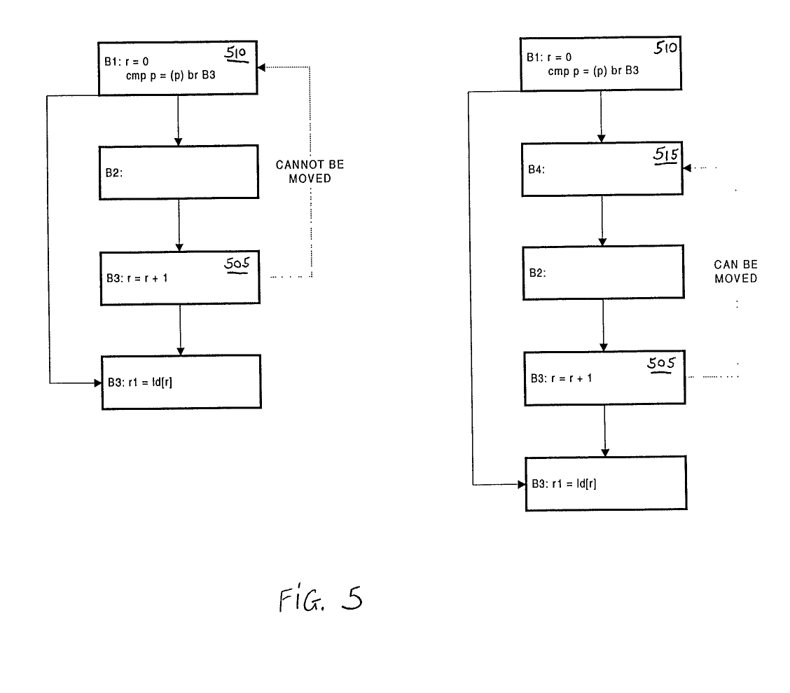

FIG. 5 provides an exemplary situation where an empty successor block may need to be created. As shown on the left of the figure, the instruction “r=r+1” in block B3 505 cannot be moved to block B1 510 since the instruction “r=0” in block B1 510 is already defined for another path. However as shown on the right of the figure, if empty block B4 515 can be created, the instruction “r=r+1” in block B3 505 can then be moved into the empty block B4 515. Furthermore, if the branch probability from block B1 510 to block B4 515 is high, block B4 515 can be included into the reuse region with block B1 510 as the new main exit.

In one embodiment, the code motion to the main exit block X of a region R can be generally described as follows.

For the main exit block X of a region R, the following operations need to be performed:

If the branch probability from the main exit block X to its most likely successor is relatively high (e.g., >0.7) and its likely successor block is not reusable, create an empty block between the main exit block X and the most likely successor block. If the empty block is created, the following operations for scheduling the main exit block X will be repeated for the empty block.

Select a single entry DAG region (SEDAG) headed by main exit block X.

Construct a dependence graph (DG) for the SEDAG. The DG contains a special instruction that uses all the registers live-out of the SEDAG. Typically, the special instruction should not be removed.

Move the reusable instruction upward to the end of the main exit block X. The reusable instruction closer to the main exit block X should have higher priority than those instructions further away from the main exit block X. If a long-latency instruction needs to be moved above a branch and the defined register that is live-out to the other target of the branch, a right-hand-split (RHS) should be used to rename the destination register.

UEU(E,R) and DED (X,R) should be computed when an instruction is considered for moving to the end of the main exit block X, assuming the instruction is at the end of the main exit block X. If either UEU(E,R) or DED(X,R) is within the limits, the instruction should not be moved. During the computation of DED(X,R), the value for LIVEOUT(X) should be updated using the following equation (3):

LIVEOUT(X)=LIVEOUT(X)∪MOVED(X), (3)

where MOVED(X) is the set of registers defined by the instructions moved into the main exit block X and at least one of the uses of the registers is still outside of the main exit block X.

After all possible instructions are moved, update LIVEOUT(B) for every block b in the SEDAG, using the DG. For each instruction I that is moved, if a use of the destination register of instruction I is the special instruction, the destination register should be marked as live-out in all blocks of the SEDAG. If a use of the destination register is in block b1 in the SEDAG, the destination register should be marked as live-out in all blocks from the main exit block X to the predecessor of block b1. It should be noted that LIVEOUT(b′) does not need to be updated for block b′ that is not in the SEDAG. Exemplary situations where LIVEOUT(b′) does not need to be updated may include:

1. The instruction I is moved without passing a branch. Therefore, it will not change live-out of any block outside the region R;

2. The instruction I is moved passing a branch with RHS. The moved instruction has a destination register that is only live to the original block of I and the block is inside the SEDAG; and

3. The instruction I is moved passed a branch without RHS. In this situation, the destination of the instruction is not live-out to the other target of the branch. After moving the instruction above the branch, if the destination register becomes live-out to the other target of the branch, then the program originally has a problem with “used before initialization”. If the program is assumed to be correct, the register will not be live-out to the other target of the branch. Therefore, the LIVEOUT information do not need to be updated for blocks on the other target.

It should be noted that for side exits other than the main exit block X, SEDAG can be formed, and instructions can be moved to the main exit block X. However, since the probability of the side exits is low, it may not be beneficial to move code from the outside to the inside of the region R.

To pull code or instructions from the predecessors of the main entry block E to the beginning of the main entry block E, code or instructions should be moved along a single entry single exit trace (SESET) since downward code motion can be complex when a side exit is allowed.

In one embodiment, the code motion to the beginning of the main entry block E can be generally described as follows:

Select a SESET ended at the main entry block E without the side exit.

Form a dependence graph (DG) for the trace. The DG should contain a special instruction that defines all the registers live-in to the trace. The special instruction should not be removed.

Schedule the reusable instructions downward to the beginning of the main entry block E. The instructions closer to the main entry block E should have higher priority than the instruction further away from the main entry block E.

When an instruction is being considered for moving to the beginning of the main entry block E, UEU(E,R) and DED(X,R) should be computed with the assumption that the instruction is at the beginning of the main entry block E. If either UEU(E,R) or DED (X,R) is not within the limits, the instruction should not be moved. It should be noted that LIVEOUT(X) should not change when instructions are moved along the trace.

After all possible instructions have been moved, LIVEOUT(b) should be updated for every block b in the SESET using the DG. For each instruction I that is moved, if the definition instruction of a source register is the special instruction, the register should be marked as live-out for all blocks in the SESET. If the definition instruction is in a block b1 inside the SESET, the register should be marked as live-out for blocks from the successor of block b1 to the predecessor of the main entry block E. It should be noted that LIVEOUT(b′) does not need to be updated for block b′ outside of the trace.

Block 320 of FIG. 3 shows a tail duplication application. As stated above, tail duplication can be applied by device 220 of FIG. 2. When a group of reusable instructions can be executed along multiple entry points, tail duplication of the reusable instructions generally allows all execution to be reused. An exemplary process of performing tail duplication will now be described in more detail.

Tail duplication can be applied in two places. After the initial regions selection, tail duplication can be applied to separate reusable instructions executed along a side entry. Furthermore, tail duplication can be applied during code motion to form a larger SEDAG.

Regarding applying tail duplication after initial regions selection, side entries, which have execution frequency greater than the minimum frequency for reuse, should be removed after the initial region information. Without the tail duplication, the execution along the side entry would not be reused. After duplication, additional reuse region along the side entry may be formed.

Regarding applying tail duplication for code motion, code motion passing side entry is generally complicated, as compensation code is typically needed. Tail duplication can be used to remove the side entries. However, before code motion is finalized, it is not known which side entry complicates code motion. As such, the largest SEDAG should be formed under the assumption that all side entries to blocks in the SEDAG will be removed. Afterward, instructions to be moved should be identified, assuming no side entry exists. Before the identified instructions are actually moved, the SEDAG should be trimmed to a minimal region that contains all the instructions that will be removed. Then, side entries before the first instruction to be removed should be removed by tail duplication in the trimmed SEDAG region. After tail duplication is applied, the instructions should then be removed.

Accordingly in one embodiment the code optimizer 102 (shown in FIG. 1) for formulating regions of reusable instructions would adopt the following logic described in the following pseudo-code.

region_formation( )
{ /* region formation device */

for each block E in topological order
begin

(X,R) = initial_region_selection(E, completion_probability)
if (X == NULL)

continue

code_motion_main_exit(X,R)
code_motion_main_entry(E,R)
if region R still has less than K instruction

delete R

/* Note that K is the required minimal number of reusable instructions */

end

}
initial_region_selection(E,completion_probability)
{ /* logic adopted by the initial region selection device 210 of Figure 2 */

reach_set = the set of reusable blocks reachable from block E without going through loop back edge

/* Note that inner loops are represented by their entry blocks */

E->set_freq(1)
X = NULL; R = NULL
Propagate_freq(E, reach_set)
for each block x in reach_set
begin

if (x->freq( ) < completion_probability)

continue

Rx = reusable blocks reachable from E and reach x

/*G<= K*/

if (SIZE(Rx) < G ∥ UEU(E,x,Rx) > N ∥ DED(E,x,Rx) > M)

continue

if X==NULL ∥ Rx is better than the selected region R

save x, Rx as the selected region (X,R)

end
return (X,R)

}
code_motion_main_exit(X,R)
{/* logic in the code motion and tail duplication devices */

setag = form_SEDAG_region(X)
dg = build_dependence_graph(sedag)
insts_to_be_moved = upward_code_motion_selection(sedag,dg,X)
sedag1 = trim_sedag(sedag,insts_to_be_moved)
tail_duplicate_region(sedag1)
update_live_out(sedag,insts_to_be_moved)
move_insts_upward(insts_to_be_moved,X)

}
code_motion_main_entry(E,R)
{ /* logic in the code motion and tail duplication devices */

sesetrace = form_SESE_TRACE_region(E)
dg = build_dependence_graph(sesetrace)
insts_to_be_moved = downward_code_motion_selection(sesetrace,dg,E)
update_live_in(sesetrace,insts_to_be_moved)
move_insts_downward(insts_to_be_moved,E)

}

It should also be noted that the functional components, as shown in the figures and described in the text accompanying the figures, could be implemented in hardware. However, these functional components can also be implemented using software code segments. Each of the code segments may include one or more assembly instructions. If the aforementioned functional components are implemented using software code segments, these code segments can be stored on a machine-readable medium, such as floppy disk, hard drive, CD-ROM, DVD, tape, memory, or any storage device that is accessible by a computing machine.

While certain exemplary embodiments have been described and shown in accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system comprising:
a compiler to generate object code from a computer program;
a code optimizer to optimize the object code generated by the compiler, the code optimizer including a first device to formulate regions, a second device to select initial regions, a third device to apply code motion, a fourth device to apply tail duplication, and a fifth device to compute UEU(E,R) and DED(X,R), wherein UEU(E,R) represents a number of upward exposed registers at a main entry E of a region R that are used in the region R and DED(X,R) represents a number of downward exposed registers at a main exit X of the region R that are defined in the region R;
a memory to store the compiler and the code optimizer; and
a central processing unit (CPU) cooperatively connected to the memory to execute the compiler and the code optimizer.

2. The system of claim 1, wherein the second device selects initial regions by selecting sub-control flow graphs as regions such that the region starts execution mostly at the main entry and completes mostly at the main exit.

3. The system of claim 1, wherein the fifth device computes UEU(E,R) and DED(X,R) using local information from the region R.

4. The system of claim 1, wherein the third device applies code motion by moving instructions outside the region R into the region R.

5. The system of claim 4, wherein the third device moves instructions outside of the region R into the main entry E and the main exit X of the region R.

6. The system of claim 5, wherein the third device moves instructions outside of the region R into the main entry E and the main exit X of the region R, and later moves the instructions from the main entry E and the main exit X of the region R to other places inside the region R.

7. The system of claim 1, wherein the fourth device applies tail duplication to separate reusable instructions executed along a side entry after selection of initial regions.

8. The system of claim 1, wherein the fourth device applies tail duplication during application of code motion.

9. A method comprising:
selecting initial regions;
computing UEU(E,R) and DED(X,R), wherein UEU(E,R) represents a number of upward exposed registers at a main entry E of a region R that are used in the region R and DED(X,R) represents a number of downward exposed registers at a main exit X of the region R that are defined in the region R;
applying code motion; and
applying tail duplication.

10. The method of claim 9, wherein the selecting initial regions includes selecting sub-control flow graphs as regions such that the region starts execution mostly at the main entry and completes mostly at the main exit.

11. The method of claim 9, wherein the computing UEU(E,R) and DED(X,R) is performed using local information from the region R.

12. The method of claim 9, wherein the applying code motion includes moving instructions outside the region R into the region R.

13. The method of claim 12, wherein the moving instructions outside the region R into the region R includes moving instructions outside of the region R into the main entry E and the main exit X of the region R.

14. The method of claim 13, wherein the moving instructions outside of the region R into the region R further includes moving instructions from the main entry E and the main exit X of the region R to other places inside the region R.

15. The method of claim 9, further comprises applying tail duplication to separate reusable instructions executed along a side entry after selection of initial regions.

16. The method of claim 1, further comprises applying tail duplication during application of code motion.

17. A machine-readable medium comprising instructions which, when executed by a machine, cause the machine to perform operations comprising:
selecting initial regions;
computing UEU(E,R) and DED(X,R), wherein UEU(E,R) represents a number of upward exposed registers at a main entry E of a region R that are used in the region R and DED(X,R) represents a number of downward exposed registers at a main exit X of the region R that are defined in the region R;
applying code motion; and
applying tail duplication.
